(19) United States
(12) Patent Application Publication
(10) Pub. No.: US 2008/0155419 A1
(43) Pub. Date: Jun. 26, 2008

(54) Method and Apparatus for Removing Partially Recorded Program

(75) Inventor: Daniel T. Mongoven, Arlington Heights, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/613,841

(22) Filed: Dec. 20, 2006

(51) Int. Cl. G06F 3/00

(52) U.S. Cl. 715/723

(57) ABSTRACT

A method and system for removal of partially recorded programs are disclosed. For example, the method presents a menu of options when interrupting a recording in progress, wherein one of the options is an option to delete a partial recording of a program. The method then receives a selection of the option to delete the partial recording of the program from a user, and immediately deletes the partial recording of the program.

### FIELD OF THE INVENTION

The present invention relates generally to processing stored programs and, in particular, processing of digital video recording of programs, e.g., cable television programs.

### BACKGROUND OF THE INVENTION

With the advent of digital video recorders (DVR) on set-top boxes, subscribers are able to watch television programs at times that are convenient to the subscriber. Specifically, set-top boxes with DVR capability are able to provide recording of programs so that the subscriber may view the stored programs at a later time.

Current DVR set-top boxes allow a subscriber to select what television programs they would like to record. Typically, an interactive program guide is displayed to the subscriber. The interactive program guide typically is in a grid format with blocks of programming. To program recordings, the subscriber simply chooses the various blocks of programming in the interactive program guide that they wish to record.

However, when a recording that is in process is interrupted, typically a partial recording of the program is left on the storage device of the DVR set-top box. Having the partial recording of the program left on the storage device of the DVR set-top box is undesirable because memory space on the storage device of the DVR set-top box is typically limited. Accumulating partially recorded programs may begin to waste the limited memory space of the DVR set-top box. Furthermore, accumulating partially recorded programs will unnecessarily add extra programs into the recorded programs list, thereby cluttering the user interface.

Currently, if the subscriber's recording that is in process is interrupted, the subscriber must press a string of inputs to find and delete the partially recorded programs. The string of inputs may be numerous, complicated and inconvenient to the subscriber. Therefore, a need exists for an easier and more efficient method and system for removing partially recorded programs.

### BRIEF DESCRIPTION OF THE DRAWINGS

The teaching of the present invention can be readily understood by considering the following detailed description in conjunction with the accompanying drawings, in which:

FIG. 1 illustrates an exemplary architectural overview of the present invention;

FIG. 2 illustrates a high level block diagram of an exemplary DVR set-top box;

FIG. 3 illustrates an exemplary flow chart of a method for removing partially recorded programs;

FIG. 4 illustrates an exemplary menu of options displayed to a user; and

FIG. 5 illustrates a high level block diagram of an exemplary general purpose computer suitable for use in performing the functions described herein.

To facilitate understanding, identical reference numerals have been used, where possible, to designate identical elements that are common to the figures.

### DETAILED DESCRIPTION

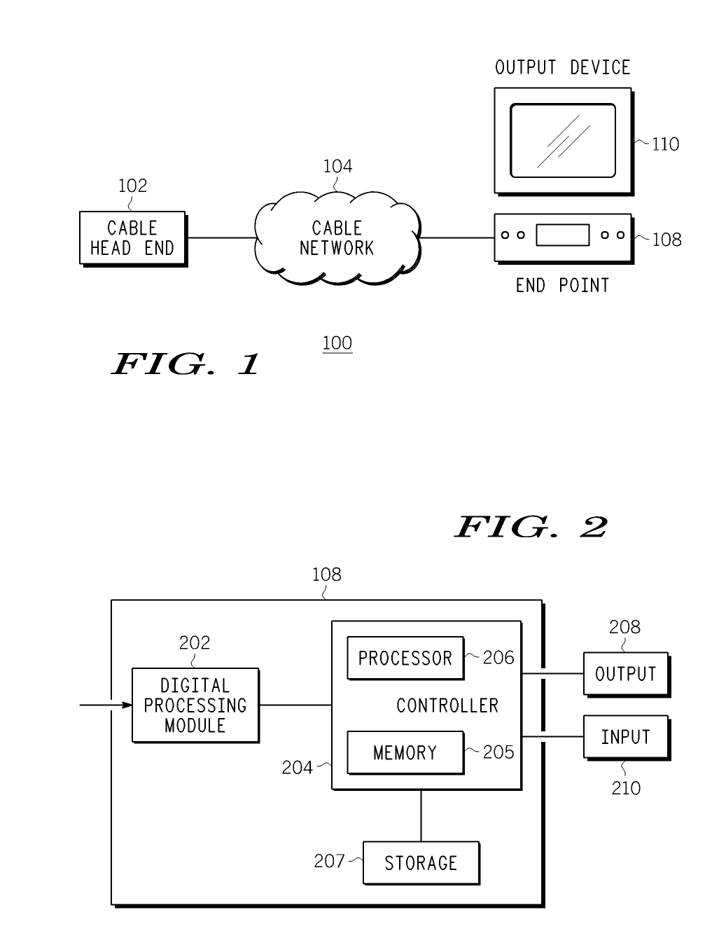

FIG. 1 illustrates an exemplary architectural overview of a network 100. In an exemplary embodiment, network 100 includes a cable head end 102, a network 104, e.g., a cable network and an endpoint 108. Cable head end 102 may provide various content such as, for example television programming, high speed internet access, digital music, high definition television programming, interactive programming guides and any combination thereof to be received by endpoint device 108. In one embodiment, cable head end 102 provides various content to a subscriber or a user via the cable network 104. Network 104 may be any type of network currently known in the art such as, for example a hybrid coaxial fiber (HFC) network for providing traditionally cable services or an Internet Protocol (IP) network. As such, the illustrative network as shown in FIG. 1 should not be interpreted to limit the present invention. Namely, the content can be transmitted via a wireless network, e.g., satellite, over the air, and the like.

Endpoint device 108 may comprise a digital video recording (DVR) set-top box that is in communication with a display 110. Display 110 may be any type of device capable of displaying content such as, for example, a television, a display, a computer monitor and the like. Although only a single endpoint device 108 and a single cable head end 102 are illustrated in FIG. 1, the present invention is not so limited. Any number of endpoint devices and cable head ends can be deployed. Moreover, although only a single DVR set-top box 108 and display 110 are illustrated in FIG. 1, those skilled in the art will recognize the present invention may have any number of DVR set-top boxes 108 and displays 110.

FIG. 2 illustrates a high level block diagram of an exemplary DVR set-top box 108. DVR set-top box 108 may comprise, for example, a signal processing module 202, a controller 204, a storage medium 207, output ports 208 and input ports 210. Signal processing module 202 may comprise a plurality of components that are used to process incoming signals from the cable head end 102. For example, signal processing block 202 may include a tuner, a demodulator, a demultiplexer, a decryptor, a decoder and the like. The operations of these components in a set-top box are well known. These components operate together to extract/decode a program signal that can be provided to a display for viewing by the subscriber.

In one embodiment, controller 204 may include a processor 206 for managing the incoming program signals, providing outputs to the display 110, receiving inputs from the subscriber or user and storing content into storage medium or device 207. Controller 204 may also include a memory 205 for storing software for executing one or more applications, such as presenting a menu of options to the subscriber that is described further below.

DVR set-top box 108 may also include/utilize a storage medium or device 207 for storing programs recorded by the subscriber. Storage medium 207 may be an internal storage device such as, for example, an internal hard drive, a random access memory, and the like. Alternatively, storage medium 207 may be an external storage device such as, for example, an external hard drive, a secure digital memory card, a compact flash memory or any combination thereof.

Outputs ports 208 may comprise any type of connections to carry programming signals to one or more displays 110. For example, output ports 208 may comprise component video connections, digital video interface (DVI) connections, High-Definition Multimedia Interface (HDMI) connections, coaxial connections, firewire connections, IP network connections or any combination thereof. Input ports 210 may comprise any type of receivers or interfaces for receiving inputs from a subscriber using, for example, a remote control. For example, input ports 210 may comprise a RF receiver, an infrared receiver and the like.

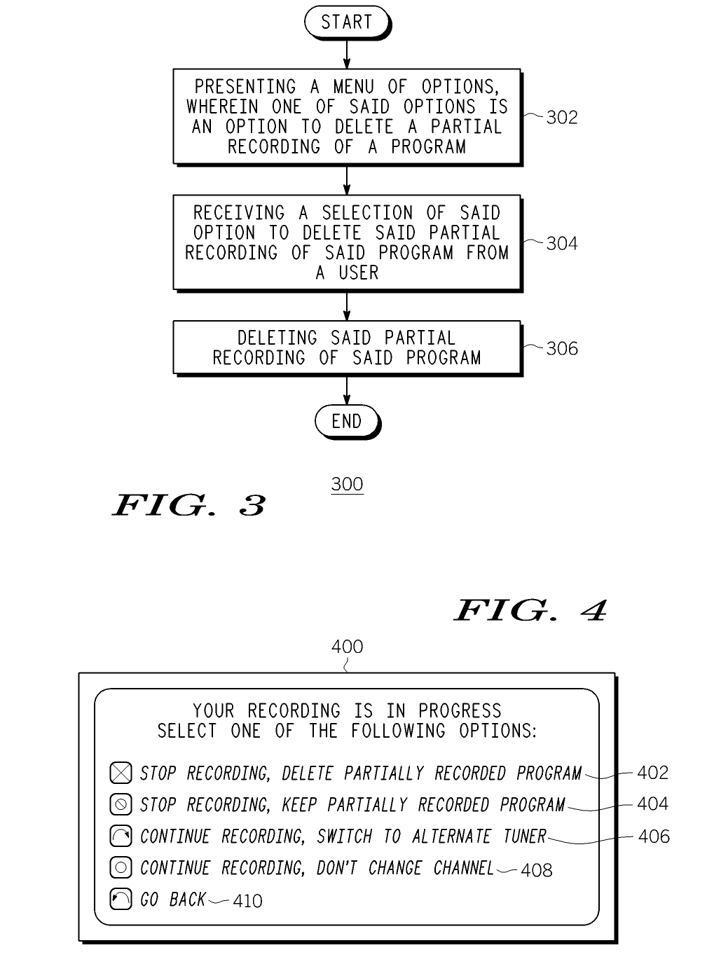

FIG. 3 illustrates an exemplary flow chart of a method 300 for removing partially recorded programs. In one embodiment, method 300 may be implemented by the set-top box 108. Method 300 begins at step 302 where a menu of options may be presented, wherein one of said options is an option to delete a partial recording of a program.

For example, an exemplary menu of options 400 (broadly defined as a recording status menu) is depicted in FIG. 4. Menu of options 400 may be presented to the subscriber on display 110 using DVR set-top box 108 (e.g., as requested by the subscriber). Menu of options may include, as discussed in step 302 of FIG. 3, an option 402 to stop recording and to delete the partially recorded program. Menu of options 400 may also include other options such as, for example, option 404 to stop recording and to keep the partially recorded program, option 406 to continue recording and to switch to the alternate tuner, option 408 to continue recording and don't change the channel and option 410 to go back to the previous screen.

The menu of options 400 of step 302 may arise when the user attempts to change channel selection or record another program, which could result in the interruption of the currently recording program. For example, a request to record a program may be received from the user. The request may be received by selecting a program block displayed to the user via an interactive program guide, as is well known in the art. The selection may be made by simply highlighting a program block of the interactive program guide and pressing a record button on a remote control. Subsequently, when the program begins, DVR set-top box 108 automatically begins recording the selected program whether the user is currently watching the selected program, watching another program or the DVR set-top box 108 is turned off.

However, DVR set-top box 108 may receive a command to interrupt the recording of the selected program. For example, the command to interrupt the recording may be an input selected by the user to change the channel, to record a different program on a different channel or to simply stop recording. Once the command (e.g., via a single input received from the user) to interrupt the recording of the selected program is received by DVR set-top box 108, DVR set-top box 108 may generate the menu of options 400 at step 302.

At step 304, method 300 receives a selection (e.g., option 402) from the displayed menu for deleting the partial recording of a program. For example, the subscriber does not want to keep the partially recorded program in the DVR set-top box 108.

At step 306, the selected partially recorded program is deleted. In an illustrative embodiment of the present invention, to delete the partially recorded program, the DVR set-top box 108 identifies a program identification (e.g., a program identification number or filename or database entry) that is associated with the partially recorded program. The program identification can be located in the storage medium 207 of DVR set-top box 108. Finally, the partially recorded program associated with said program identification is removed from storage medium 207.

Notably, the above method describes a more efficient and simpler method to remove partially recorded programs from a DVR set-top box 108. Currently, if a user wishes to remove a partially recorded program from a DVR set-top box 108, the user must navigate through a series of menus to delete the partially recorded program. For example, it is often necessary to navigate through a series of menus before the partially recorded program is identified to the subscriber. Only then is the subscriber allowed to select the deletion option to delete the partially recorded program.

In contrast, the embodiments of the present invention provide a method of deleting a partially recorded program via having to navigate only one menu, e.g., a recording status menu 400. In other words, the deletion of the partially recorded program may be performed in response to a single input from a user after the menu of options of the recording status menu 400 is presented. For example, the recording status menu 400 can be displayed upon receiving a single request from the user remote device, e.g., depressing a single control button (e.g., a status button/channel select button) on the remote device. In turn, selecting option 402 of FIG. 4 will cause the partially recorded program to be deleted immediately.

Therefore, management of generally limited storage space on DVR set-top box 108 is much simpler. Users are able to more quickly and efficiently delete partially recorded programs.

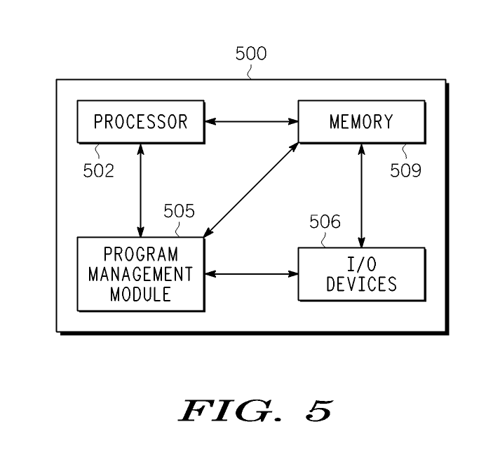

FIG. 5 illustrates a high level block diagram of an exemplary general purpose computer suitable for use in performing the functions described herein. As depicted in FIG. 5, the general purpose computer 500 comprises a processor element 502 (e.g., a CPU), a memory 504, e.g., random access memory (RAM) and/or read only memory (ROM), a program management module 505 for removing partially recorded programs, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the processes provided by the present program management module 505 can be loaded into memory 504 and executed by processor 502 to implement the functions as discussed above. As such, the processes provided by the program management module 505 for removing partially recorded programs (including associated data structures) of the present invention can be stored on a computer readable medium or carrier, e.g., RAM memory, magnetic or optical drive or diskette and the like.

While the foregoing is directed to illustrative embodiments of the present invention, other and further embodiments of the invention may be devised without departing from the basic scope thereof, and the scope thereof is determined by the claims that follow.

What is claimed is:

1. A method of removing a partially recorded program that is received via a network, comprising:
presenting a menu of options, wherein one of said options is an option to delete a partial recording of a program;
receiving a selection of said option to delete said partial recording of said program from a user; and
deleting said partial recording of said program.

2. The method of claim 1, wherein said menu of options is presented in response to a single input from said user.

3. The method of claim 1, wherein said partial recording of said program is deleted from a digital video recording (DVR) set-top box.

4. The method of claim 1, further comprising:
receiving a request to record said program;
recording said program; and
receiving a command to interrupt said recording of said program.

5. The method of claim 4, wherein said command to interrupt said recording comprises at least one of: a command to change a channel, a command to stop recording, or a command to record a different program on a different channel.

6. The method of claim 1, wherein said menu of options further comprises an option to continue recording and change to a different channel, an option to continue recording and do not change to a different channel, and an option to stop recording and to keep said partial recording of said program.

7. The method of claim 1, wherein said program is currently being watched by said user.

8. The method of claim 1, wherein said deleting comprises:
identifying a program identification associated with said partial recording of said program;
finding said program identification on a storage medium; and
removing said partial recording of said program associated with said program identification.

9. The method of claim 1, wherein said deleting said partial recording of said program is performed in response to a single input received from said user after said menu of options is presented.

10. A system of removing a partially recorded program, comprising:
a storage medium for storing a partial recording of a program; and
a controller, coupled to said storage medium, for presenting a menu of options, wherein one of said options is an option to delete said partial recording of said program, where said controller is for receiving a selection of said option to delete said partial recording of said program from a user, and for deleting said partial recording of said program from said storage medium.

11. The system of claim 10, wherein said menu of options is presented in response to a single input from said user.

12. The system of claim 10, wherein said storage medium and said controller are deployed within a digital video recording (DVR) set-top box.

13. The system of claim 10, wherein said controller receives a request to record said program, wherein said controller records said program onto said storage medium, and wherein said controller receives a command to interrupt said recording of said program.

14. The system of claim 13, wherein said command to interrupt said recording comprises at least one of: a command to change a channel, a command to stop recording, or a command to record a different program on a different channel.

15. The system of claim 10, wherein said menu of options further comprises an option to continue recording and change to a different channel, an option to continue recording and do not change to a different channel, and an option to stop recording and to keep said partial recording of said program.

16. The system of claim 10, wherein said program is currently being watched by said user.

17. The system of claim 10, wherein said controller deletes said partial recording of said program comprises:
identifying a program identification associated with said partial recording of said program;
finding said program identification on said storage medium; and
removing said partial recording of said program associated with said program identification.

18. The system of claim 10, wherein said controller deletes said partial recording of said program in response to a single input received from said user after said menu of options is presented.

19. A computer-readable medium having stored thereon a plurality of instructions, said plurality of instructions including instructions which, when executed by a processor, cause said processor to perform said steps of a method of removing a partially recorded program that is received via a network, comprising:
presenting a menu of options, wherein one of said options is an option to delete a partial recording of a program;
receiving a selection of said option to delete said partial recording of said program from a user; and
deleting said partial recording of said program.

20. The computer-readable medium of claim 19, wherein said menu of options is presented in response to a single input from said user.
